(19) United States
(12) Patent Application Publication
(10) Pub. No.: US 2018/0247264 A1
(43) Pub. Date: Aug. 30, 2018

(54) INVENTORY MANAGEMENT SYSTEMS, DEVICES AND METHODS

(71) Applicant: WAL-MART STORES, INC., Bentonville, AR (US)

(72) Inventors: Robert James Taylor, Rogers, AR (US); Jeffrey Scott Cruz, Bentonville, AR (US); William M. Propes, Bentonville, AR (US); Ryan Travis, Fayetteville, AR (US); Matthew D. Alexander, Rogers, AR (US); Leigh Ann Marie Scobey, Bentonville, AR (US); Marc Fletter, Bentonville, AR (US); Jamison Sibley, Rogers, AR (US); Aaron Vasgaard, Rogers, AR (US); Nicholaus A. Jones, Fayetteville, AR (US); Matthew Jones, Bentonville, AR (US)

(21) Appl. No.: 15/883,747

(22) Filed: Jan. 30, 2018

Related U.S. Application Data
(60) Provisional application No. 62/464,418, filed on Feb. 28, 2017.

(51) Int. Cl. G06Q 10/08; G06Q 10/06; G06Q 10/04

(52) U.S. Cl. CPC G06Q 10/0875; G06Q 10/047; G06Q 10/06316

(57) ABSTRACT

Systems and methods described herein relate to scheduling and coordination of particular tasks based upon dynamically updated product inventory data. These systems and methods increase the efficiency of stocking and fulfillment as well as inventory auditing of the inventory.

### RELATED APPLICATION

The present application claims the benefit of U.S. Provisional Application No. 62/464,418 filed Feb. 28, 2017, which is hereby incorporated herein in its entirety by reference.

### TECHNICAL FIELD

Embodiments relate to digital computing or data processing equipment or methods specially adapted for specific functions. More particularly, embodiments relate to inventory management systems, devices, and methods that can automate tools to guide personnel through an inventory audit process.

### BACKGROUND

Inventory management is a complex task for retailers and other businesses. Inventory audits are carried out periodically in order to determine that expected products, and quantities of products, are in fact received and/or available. During inventory audits, large retailers have the added challenges of accounting for products in multiple locations, dealing with SKU (stock keeping unit) complexity, and managing the decisions made by multiple personnel involved in the inventory and auditing processes.

Conventionally, cyclical audits can be performed to inventory individual sections of a store. Performing occasional audits of sections of the store results in wasted resources spent auditing areas that do not need frequent inventory checks and leaves potential gaps when certain areas needing more frequent inventorying are neglected. Furthermore, a manager or other centralized resource must typically wait for the results of each task (such as inventory checks) and then dispatch associates to conduct follow-up actions. Often the instructions given to a particular associate are not optimized for efficiency, such that the associate spends more time than necessary walking between points where different tasks should be performed.

Additionally, associates may not react to updated information immediately, or that information may not make it back to a manager or other centralized authority for delegating workflow in a timely fashion. For example, if a customer would like to purchase a product that is not on the shelves but is available in topstock or a backroom, the customer may inquire with an associate. If the associate is busy with another task, the shelf may nonetheless remain unstocked until that other task is complete. This is true even where the other task is of relatively lower priority than the unstocked shelf.

Similar inefficiency in delegation of tasks to associates as well as inefficiency in quickly resolving higher-priority tasks can occur with respect to product labeling, product expiration, or any number of other routine tasks in a store or similar facility.

### SUMMARY

According to an embodiment, an inventory auditing management system includes an optical detection subsystem including an optical sensor and configured to autonomously communicate realtime on-shelf customer availability (OSCA) of a product, product position, and product orientation based on optically detected information. The inventory management system can also include a weight detection subsystem including a weight sensor and configured to autonomously communicate OSCA of a product and product position based on weight distribution on a shelf. The inventory management system can also include a plurality of handheld devices each having a display, each of the plurality of handheld devices configured to host an instance of an inventory audit application programming interface (API) to present one of a plurality of different dynamic audit task lists in the corresponding display. A host device can be communicatively coupled to the optical detection subsystem, the weight detection subsystem, and each of the plurality of handheld devices. The host device can include an inventory database comprising product perpetual inventory data, a rules engine module configured to carry out a set of inventory audit rules, at least one of the set of inventory audit rules comprising a prioritization definition based on at least one of the product perpetual inventory data, the realtime OSCA, the product position, and the product orientation, and an instance of the inventory audit API configured to build the plurality of different dynamic audit task lists based on the set of inventory audit rules and the OSCA of a product, product position, and product orientation obtained from the optical detection subsystem and the weight detection subsystem.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a simplified schematic diagram of a system according to an embodiment.

FIG. 2 is a schematic view of a server according to an embodiment.

FIG. 3 is a flowchart of a method according to an embodiment.

FIGS. 4A-4D are views of a graphical user interface displaying instructions according to a dynamic audit task list according to an embodiment.

FIGS. 5A and 5B are views of a graphical user interface displaying instructions according to a dynamic audit task list according to an embodiment.

FIGS. 6A and 6B are a set of graphical user interface (GUI) screens associated with printing additional labels according to an embodiment.

FIGS. 7A and 7B are a set of GUI screens associated with inventory sizing according to an embodiment.

FIG. 8 is a view of a graphical user interface displaying an instruction according to a specific task according to an embodiment.

FIGS. 9A-9C are GUI screens related to other features of embodiments of the system.

FIGS. 10A and 10B depict visual data corresponding to product placement according to an embodiment.

FIG. 11 is a simplified schematic of a shelf having autonomous weight and visual detection systems, according to an embodiment of an inventory management system.

FIG. 12 is an instruction screen of an API of an inventory management system according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments described herein include systems and methods for managing inventory, such as at a store. According to some embodiments, systems prompt users to conduct inventory checks according to inventory audit rules that reduce inefficiency and enhance the accuracy of inventory information available. Efficiency can be increased by prioritizing inventory checks in areas where there has been some indication that there is little or no stock. Other examples of the criteria by which the inventory checks are conducted can include historical inventory errors, a lack of recent inventory checks, or products and sections of a store that require resolution of past inventory issues.

In embodiments, the systems and methods can improve the efficiency of inventory checks by directing users to areas of the store that are close to their current location to reduce time spent moving between various locations, or planning sequential tasks in a way that minimizes unnecessary movement. Likewise, efficiency can be improved by providing information to the person checking inventory regarding available overstock, and comparing the amount that fits on the shelf to the amount available in overstock or other storage locations.

In embodiments, the improvements in efficiency and inventory management can be tied to detection systems that use optical data, weight data, or a combination thereof to determine when products are understocked, overstocked, or stocked inefficiently. Such product stocking detection systems can autonomously communicate with an inventory management system to direct activities within a retail environment.

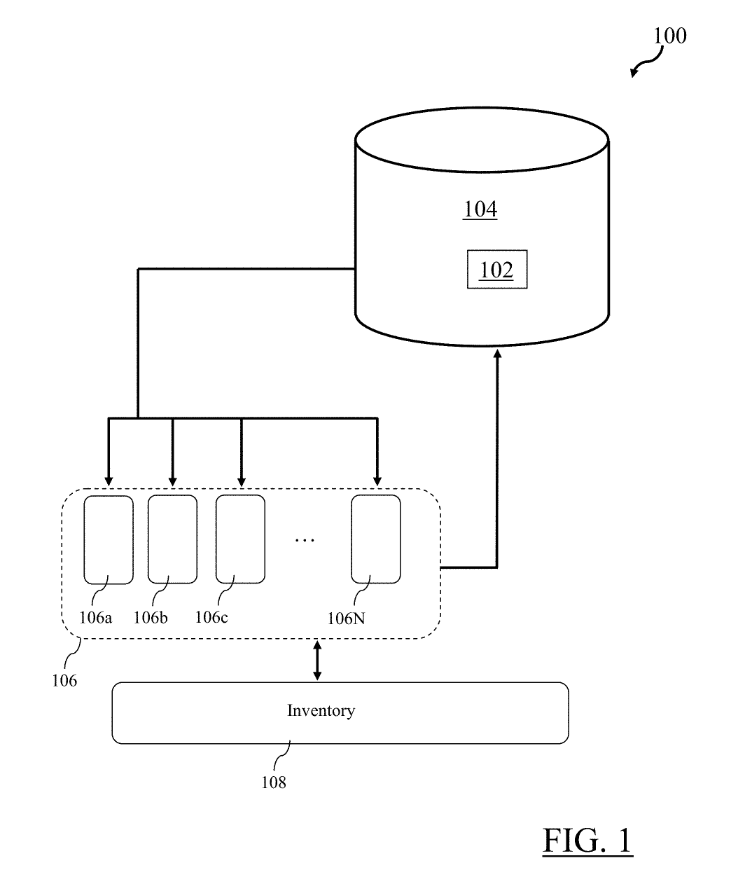

FIG. 1 is a simplified schematic diagram of a system 100. System 100 is configured to efficiently monitor one or more quantities of inventory available in a store or other physical location. System 100 of FIG. 1 includes a rules engine 102 located at a server 104. Rules engine 102 is configured to use data stored on or arriving at server 104 to direct inventory monitoring activities.

Rules engine 102 directs server 104 to send instructions to at least one remote device 106. In the embodiment shown in FIG. 1, the at least one remote device 106 is a plurality of mobile electronic devices {106a, 106b, 106c, . . . 106N}. In embodiments, these mobile electronic devices can be a cellular phone or smartphone, a tablet computer, a mobile retail computer device, any other mobile device capable of scanning barcodes, QR codes, or other labels throughout the store, or any other device that can communicate with server 104 and be used to input data either by scanning or manual data entry. In embodiments, the mobile retail computer devices 106a-106N can include an MC40 or a TC70 retail scanning device. Directions from server 104 to the mobile electronic devices 106a-106N are indicated with the downward facing arrows of FIG. 1.

Based upon the instructions received at the mobile electronic devices 106a-106N, the users of those devices can move throughout the store as directed carry out inventory-related tasks related to one or more products. In embodiments, server 104 can direct deployment of subsets of mobile electronic devices 106a-106N to different sections of the store based upon the priorities defined by rules engine 102. For example, server 104 may direct the first available mobile electronic device (e.g., mobile electronic device 106a) to a section of the store that has the highest priority need for an inventory check. The next available mobile electronic device 106b can be allocated to the same section as the first mobile electronic device 106a, or alternatively rules engine 102 may direct the second mobile electronic device 106b be deployed by server 104 to the region having the second-highest priority need for an inventory check. In general, rules engine 102 will direct each device 106 (i.e., a user of each device 106) based on specific tasks to perform, organized in a task list and discussed in more detail below.

Inventory 108 is distributed throughout the store. In many stores, inventory 108 is arranged in a variety of sections corresponding to a type of inventory 108. A quantity of each type of inventory 108 can be measured by the mobile electronic devices 106a-106N. Depending on the type of inventory, data regarding inventory of each type of inventory 108 can be measured by a scanner or barcode reader in the mobile electronic device 106, or a QR code can be scanned, or for some large, bulky, or non-countable products (such as products sold by weight) a user of the mobile electronic device may manually enter a quantity of remaining inventory 108 for a particular type or category.

Inventory 108 can be categorized by several different fields, and information relating to each of those fields can be monitored at server 104 to improve store efficiency and customer experience. For example, inventory 108 can be classified by whether it is on a shelf, in topstock or overstock, in storage at some other location, or in transit. Similarly, inventory 108 can be categorized by whether it is boxed or unpackaged on the shelf or in overstock. Inventory 108 can include expiration dates or other data in some situations.

Mobile electronic devices 106a-106N measure the fields of interest for inventory 108 (shown in FIG. 1 by the double-headed arrow) and transmit that information back to server 104 (shown in FIG. 1 by the arrow pointing upwards). For example, first mobile electronic device 106a can measure a number of one type of inventory 108 available on a shelf and transmit that information to server 104. Second mobile electronic device 106b can, simultaneously or separately, measure a number of a second type of inventory 108 available on a shelf at a different section of the store and transmit that information to server 104. Additionally or alternatively, these or other mobile electronic devices 106 can measure other fields such as the availability of overstock material, expiration dates of the remaining available inventory 108, or manually entered quantities or weights of other inventory 108. In embodiments, some or all measurement can be performed manually, such as by a user of a device 106 being prompted to count the number of a product available on a shelf and input the counted number into device 106.

System 100 of FIG. 1 can be dynamically updated based on other information entered at any location throughout the store, rather than just the section in which each mobile electronic device 106 is positioned. For example, where a customer informs an associate in a store that there is no available stock of a particular product, the associate can enter that information and send it back to server 104, even if the associate is not physically present at the location where the inventory 108 should be. Information entered in this way may be received at server 104 and affect the priority assigned by rules engine 102 for subsequent deployments of the various mobile electronic devices 106 or the tasks directed by devices 106. In the example above, in which an associate has been informed that a particular type of inventory 108 is out of stock, rules engine 102 may request that server 104 deploy an associate or machine with a mobile electronic device 106 to an expected location of that particular inventory 108. The associate can then verify whether the product is out of stock, and/or take other actions such as providing additional inventory 108 on the shelf from topstock or overstock or requesting more of that particular product from some other location.

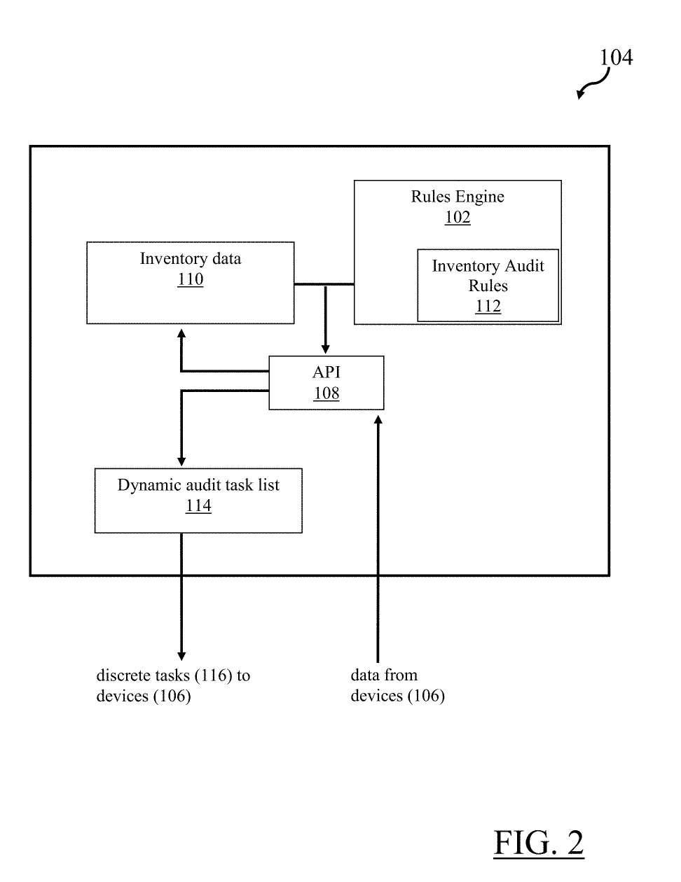

FIG. 2 is a schematic view of a server 104 according to one embodiment. Server 104 contains rules engine 102, an inventory audit Application Program Interface (API) 109, and a set of inventory data 110. Rules engine 102 includes inventory audit rules 112. API 109 uses inventory data 110 and analyzes it in view of the inventory audit rules 112 of the rules engine 102. From these data 110 and rules 112, API 109 generates a dynamic audit task list 114.

In embodiments, inventory data 110 can include product perpetual inventory data and/or other types of inventory data. Product perpetual inventory data can include shelf capacity, modular or planogram information, bin quantity information, or feature information data, for example. Other inventory data can include the quantity on-hand in various locations both onsite at a store and offsite (e.g., in transit or at a warehouse).

Dynamic audit task list 114 is used to generate discrete tasks 116 that are sent to mobile electronic devices 106, as indicated by the arrow leaving server 104 and as previously described with respect to FIG. 1. Likewise, data from devices 106 can be routed back to server 104 from devices 106. API 109 may modify the dynamic audit task list 114 based upon data received from devices 106. For example, dynamic audit task list 114 may direct different discrete tasks 116 to devices 106 based upon input data showing that the stock of a particular type of inventory 108 is low, or cannot be found. Similarly, completed audits of inventory 108 of a particular product or section may cause the dynamic audit task list 114 to change in order to allocate discrete tasks 116 differently.

In embodiments, rules engine 102 can include one or more types of inventory audit rules 112. For example, in one embodiment, one of the inventory audit rules 112 is a prioritization definition based on a real time on-shelf customer availability (OSCA) of a particular product. Additionally or alternatively, an inventory audit rule could be a prioritization definition based on reconciling historical inventory errors, a prioritization definition based on products or sections of products not inventoried recently, or a prioritization definition based on products or sections of products requiring resolution of past inventory issues, for example. Still other prioritization definitions can be set based on the practices, preferences or demands of any particular retailer or related to any particular department or product. For example, departments in which auditing is required based on product “sell by” or expiration dates may have special prioritization definitions for monitoring these products and dates.

API 109 can not only modify dynamic audit task list 114 based upon a selected rule or set of rules 112, but also the inventory data 110. Inventory data 110 can be used by API 109 to determine where, based upon the rules 112, an inventory should take place. This information can be used to define one or more discrete tasks 116. Likewise, API 109 can update inventory data 110 based upon information received from devices 106. This information can be supplemented by data from other devices, such as cash registers.

Inventory data 110 can include not only a quantity of inventory 108, but also a product location. As such, API 109 can build a set of different dynamic audit task lists based at least in part on an efficient physical route to be taken between the locations of that product or locations of products to be checked sequentially. In embodiments, inventory audit rules 112 may prioritize efficient routes over inefficient routes in order to complete audit tasks more quickly.

Discrete tasks 116 can include audit functions for inventory 108, as described above. Furthermore, discrete tasks 116 can include non-audit tasks. For example, discrete tasks 116 could include such tasks as product stocking or fulfillment. In embodiments, the discrete tasks 116 can include a set of binary questions, such as whether a product is available in an inventory overstock location. In other embodiments, an associate could be prompted to fill in a number of the inventory in the overstock location, or to scan all remaining inventory 108 of a particular type. These tasks or questions can be completed or answered on a mobile electronic device 106 in response to a prompt. The prompt can be visual, haptic, audible, or some combination thereof, in various embodiments, alerting an associate having the device 106 that a task requires attention.

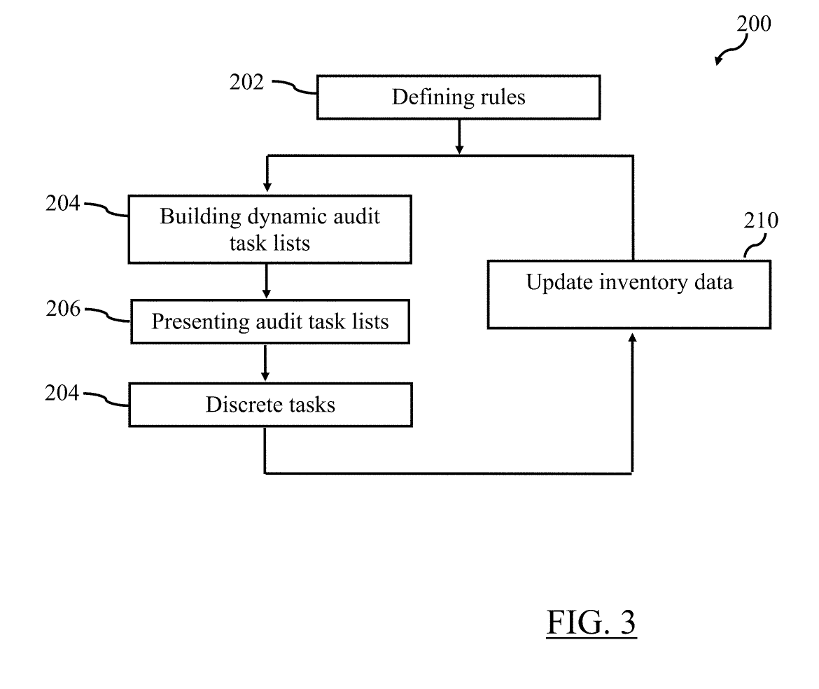

FIG. 3 is a flowchart of a method 200 of managing inventory auditing. Method 200 includes defining rules 202. Defining rules 202 can include defining a set of inventory audit rules, at least one of which includes a prioritization definition based on a real time on-shelf customer availability (OSCA) of a product, and storing the defined set of inventory rules in a rules engine.

Defined rules and inventory data are combined to build dynamic audit task lists 204. Building the dynamic audit task lists 204 includes using an inventory audit API to build a plurality of different dynamic audit task lists based on the set of inventory audit rules from 202 and the inventory data (e.g., 110 of FIG. 2) from an inventory database.

Audit task lists can be presented 206 at a set of mobile electronic devices. Each of the dynamic audit task lists of a hosted instance of the inventory audit API can be sent for presentation on a different mobile electronic device, in embodiments. Presenting the dynamic audit task lists 206 can include providing a series of discrete tasks 208 of the dynamic audit task list in a user interface of each of the mobile electronic devices.

At 210, data corresponding to each discrete task is received and used to update the inventory data in the inventory database. As shown in FIG. 3, the method is circular, and the rules defined at 202 can be applied to the updated data at 210 in a dynamic loop.

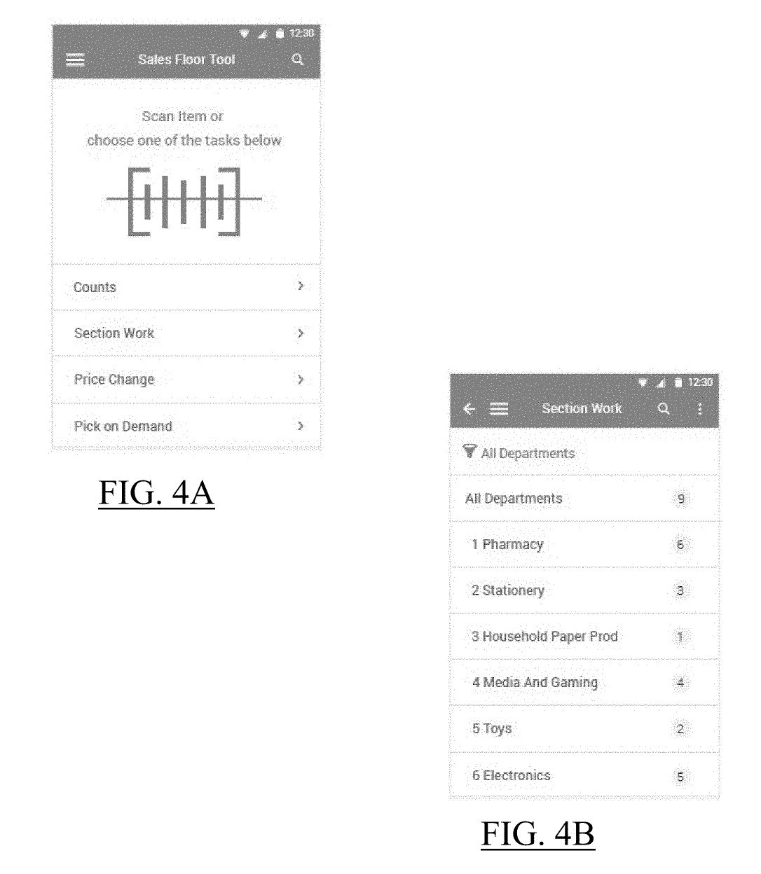

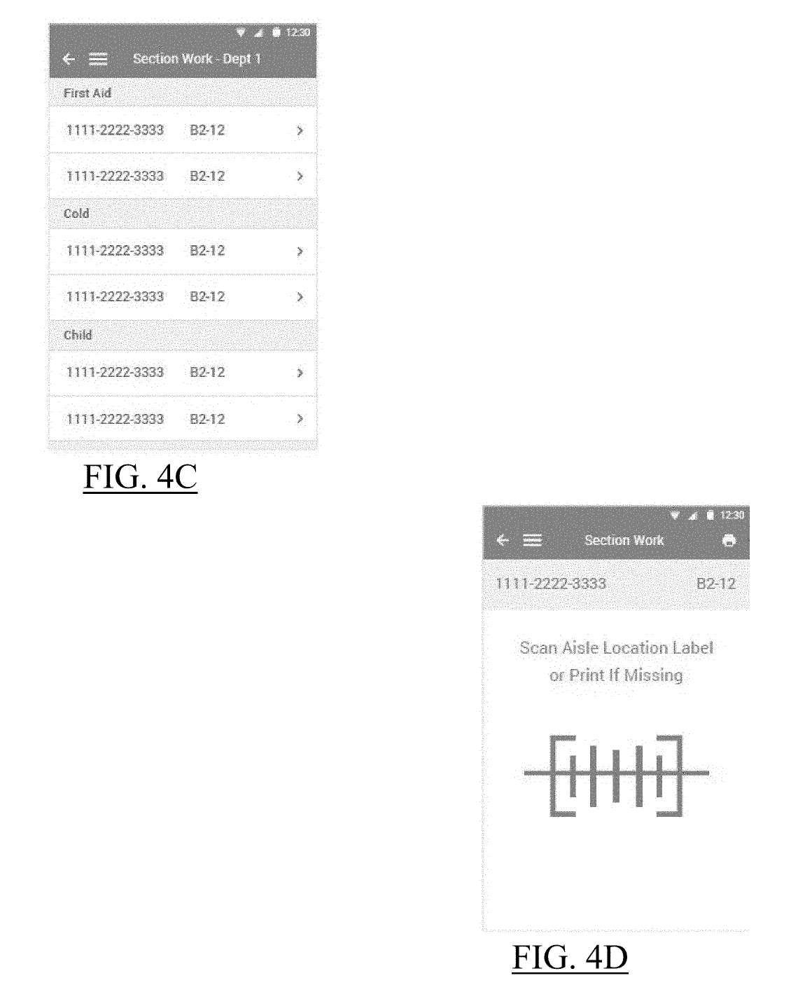

FIG. 4A is an example of a graphical user interface (GUI) displaying a dynamic audit task list. The display shown in FIG. 4A could be found on a screen of a mobile electronic device, according to an embodiment of the systems and methods described above. As shown in FIG. 4A, a main screen gives options to a user such as a sales associate to scan an item or choose from a series of tasks.

FIG. 4B shows the same GUI when the user selects “section work” from FIG. 4A. As shown in FIG. 4B, section work has been categorized and prioritized within six different sections.

FIG. 4C shows particular scanned items within a particular section audit. FIG. 4D shows the GUI when a particular product is selected for scanning.

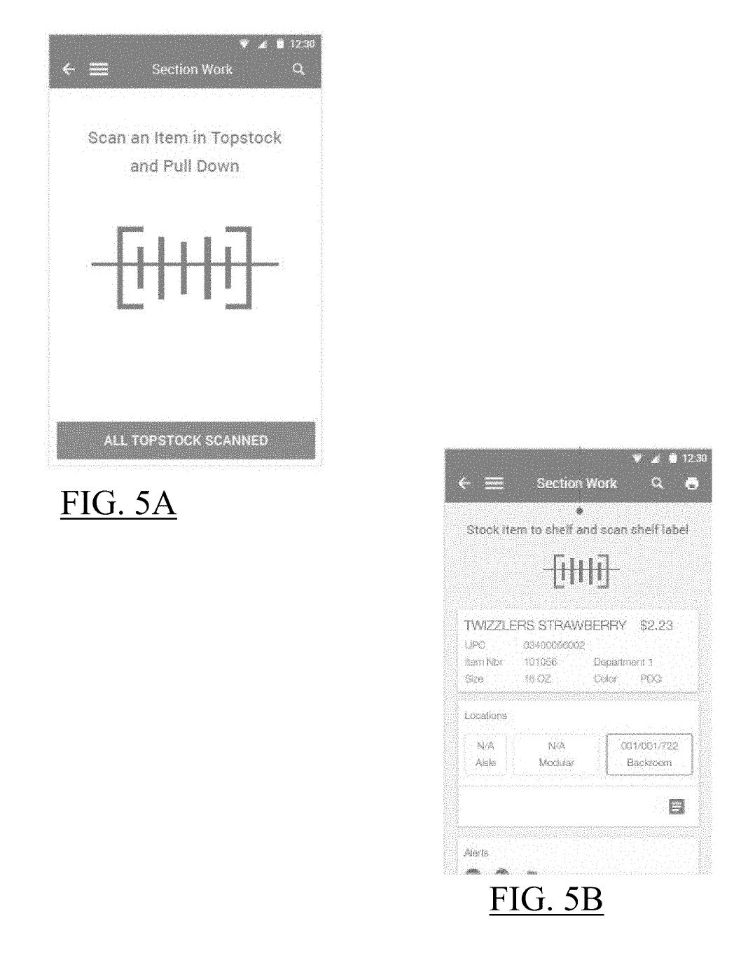

In embodiments, the GUI can direct an associate to scan an item from topstock and to pull the topstock down to the shelf level, as shown in FIG. 5A. FIG. 5B depicts a GUI screen of the system showing that there may be additional inventory in a backroom. In various embodiments, the systems and methods described herein could indicate to an associate where, among a variety of locations, additional stock can be found to replenish shelves where inventory has become low or is expected to become low.

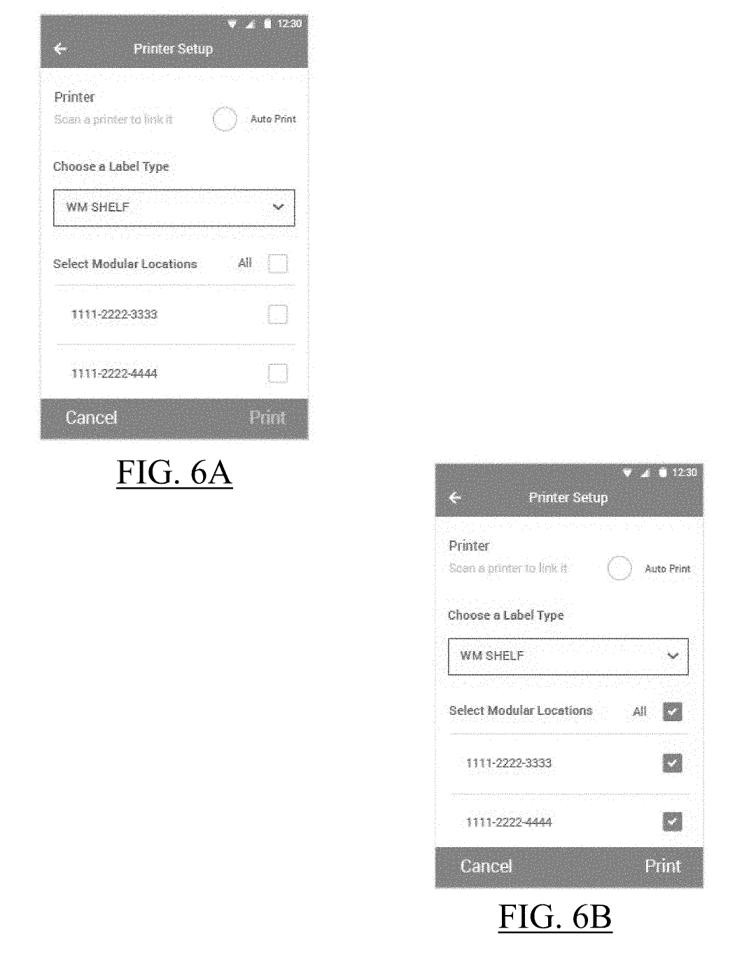

FIGS. 6A and 6B depict a set of GUI screens associated with printing additional labels. As with products, proper labeling or relabeling is among the discrete tasks that can be assigned by the system. For example, new labeling may be required due to price changes, new products being placed on the shelves, and discounts or other promotions.

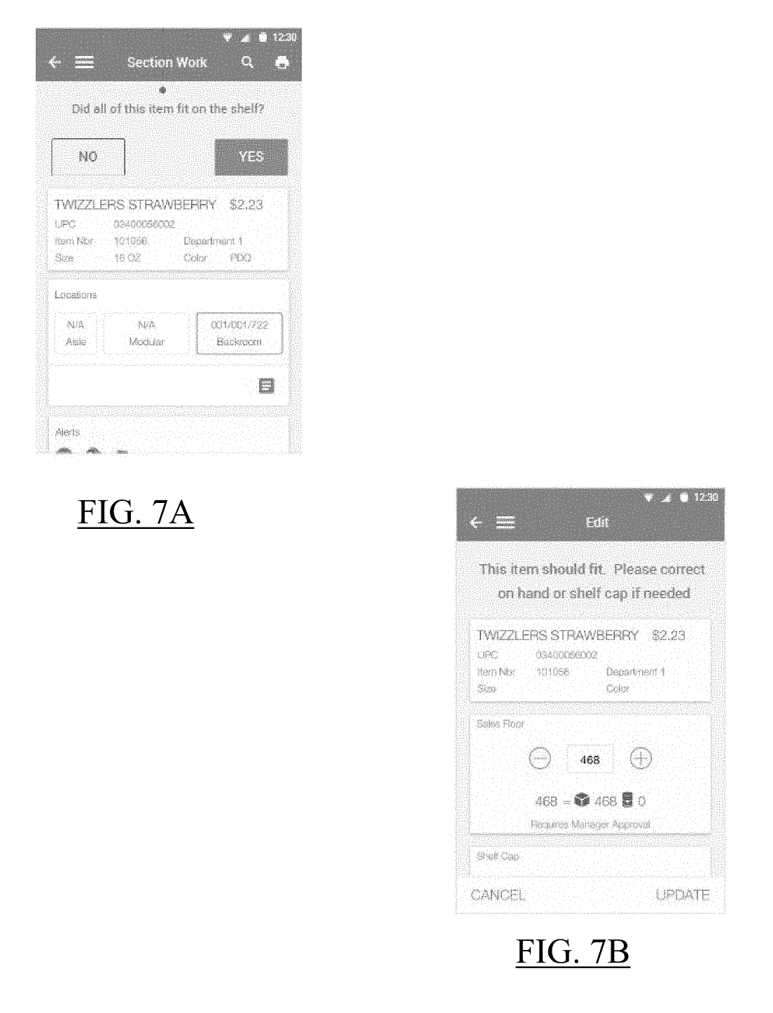

FIGS. 7A and 7B depict a set of GUI screens associated with inventory sizing. As shown in FIG. 7A, an associate has the option to select whether the excess inventory added to a shelf will fit on that shelf. For example, where topstock is moved down to a shelf, the associate can indicate on the mobile electronic device whether the entirety of a case, box, or other bulk package will fit onto a shelf. Rules (e.g., rules 102 of FIG. 1) can be set such that the API (e.g., API 109 of FIG. 2) can determine whether all of the overstock material can be added to the shelf. In the even that there is a mismatch between the determination made by the API and the feedback from the associate via the mobile electronic device, the screen shown in FIG. 7B may be presented on the mobile electronic device, providing an opportunity for the associate to update the inventory data.

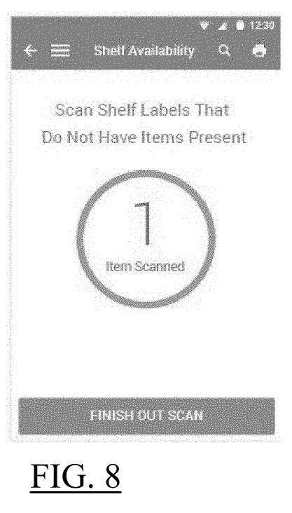

FIG. 8 is a GUI screen associated with a specific task. As shown in FIG. 8, the specific task is determining whether any shelves do not have items present. This data may be used by the API (e.g., API 109) to update the inventory data, and also to set other tasks including, for example, restocking or reordering the product that should be present on those particular shelves which are empty.

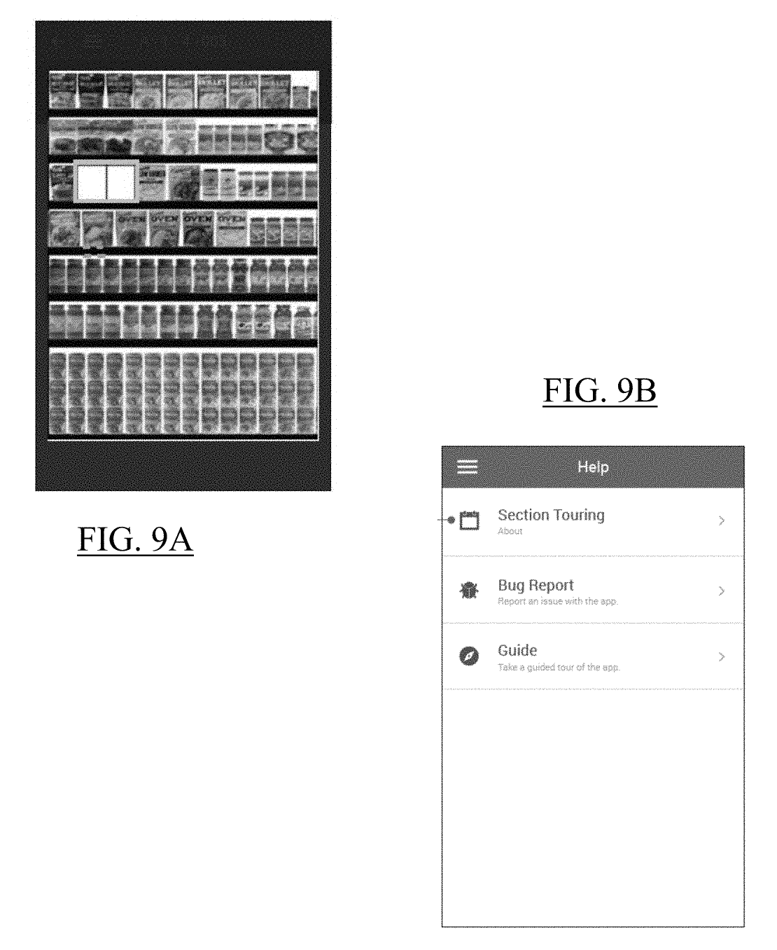

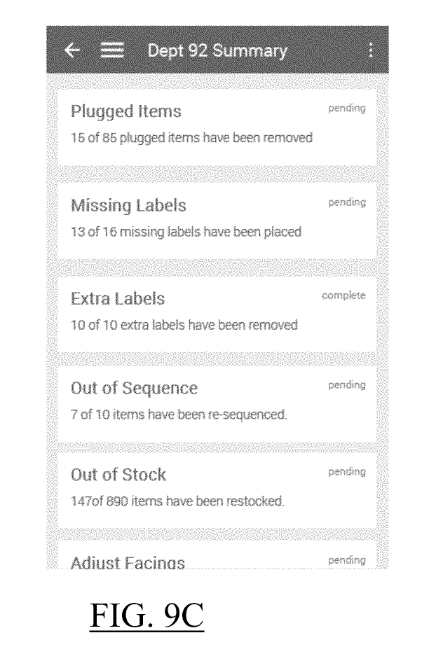

FIGS. 9A, 9B and 9C are other example GUI screens. FIG. 9A, for example, is a photo depiction of shelf, which can aid an associate in locating the particular product or area that is to be attended to for a particular task. FIG. 9B is an access screen to a help or bug reporting portion of the system. This can provide a quick and easy way for field users to report issues or obtain assistance as they work with and in the system.

Embodiments also can provide various summary and report features, which may be used by field-based associates, managers or others. FIG. 9C is an example department report, which provides a status overview of inventory task-related progress in a particular department.

When operating on certain devices, the GUI is touchscreen-compatible, such that associates need only tap, swipe, pinch and/or use other known touchscreen gestures in order to interact with the system. Certain actions can bring up keyboards, camera or scanner functions, or other features of the device that are compatible with embodiments of the GUI or system for gathering information. In some embodiments, the devices can be equipped with geolocation and mapping functions that enable tasks to be viewed graphically or spatially (i.e., on a map or illustration of the retail store presented on the GUI) or paths between tasks to be illustrated and updated in real time as the associate moves around in the store.

The systems and methods described above reduce lost sales due to inefficient or ineffective stocking of shelves and other areas within a store. Various algorithms can be developed to set appropriate rules that will direct associates to carry out audits. These rules can increase proper stocking of inventory, while also preventing repetition of work and correcting historical errors.

The systems and methods described herein can be dynamically updated, and can be used by several associates or other users at the same time. The specific tasks assigned to each unit can include section work as well as refreshing and maintaining label integrity. In embodiments, label integrity includes several aspects such as ensuring proper location of the shelf label, food supplement program labels such as Women, Infants, and Children food support (WIC) labels, labels that indicate units of measure, labels that indicate country of origin, special pricing or discounts, clearance items, or expiration dates. Specific tasks can include not only adding product to shelves but also removing it, such as in the event of a recall or other safety concern, or based upon expiration dates for a product.

In all, the systems and methods described herein provide dynamic scheduling based on past data, and efficiently route the performance of tasks. This increases the efficient stocking, fulfillment, and auditing of the store by coordinating simultaneous efforts of the associates without conducting redundant audits and without missing important tasks elsewhere.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

The systems described above are displayed on a handheld unit to direct restocking or other inventory management actions, based on counts or measurements that can be taken or entered by a handheld device in the possession of an associate or other retail employee. In embodiments, however, increased efficiency can be achieved with the use of sensing technology that autonomously reports information to a central server or other processor. Autonomous reporting can improve the timeliness of information gathering regarding product location and other important information.

Autonomous detection systems can include, for example, optical sensors. Optical sensors come in a variety of types, including radio frequency identification RFID (emitting and sensing radio-frequency light), NFC near field communication (emitting and sensing radio-frequency light), and cameras (sensing visible light). Cameras can be particularly useful for autonomous detection because, unlike RFID and NFC sensors, they need not emit any signal.

Furthermore, cameras can detect data that is not available to an RFID or NFC sensor. For example, cameras can detect a barcode or QR code. Additionally, cameras can detect not just a quantity of product at a location, but also the orientation of that product. In embodiments, a camera can detect visual data such as the orientation of a product (i.e., whether the label is facing forward), the position of the product at a shelf or other display, and whether the product is obstructed by some obstacle or other product. Cameras can often detect the same information that would otherwise be detected by RFID or NFC sensors, such as the quantity of an available product or the availability of additional supplies in top-stock or other locations.

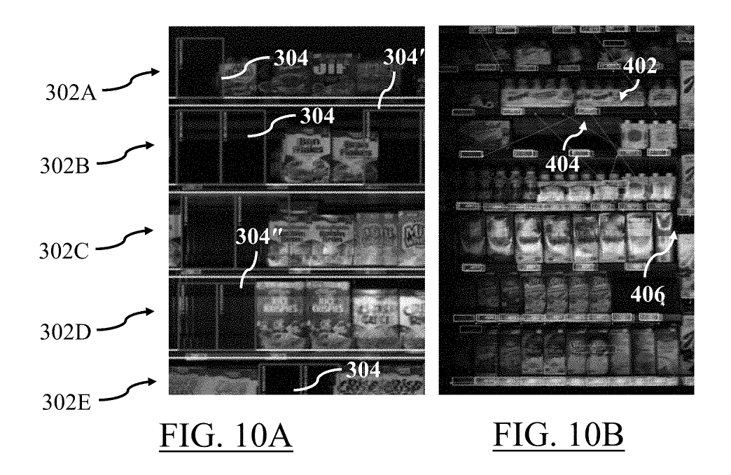

FIGS. 10A and 10B are examples of optical data detected by a camera. FIG. 10A is a picture detected by a camera, showing portions of five shelves (302A, 302B, 302C, 302D, 302E). Frames 304 correspond to portions of shelves (302A, 302B, 302C, 302D, 302E) where the camera detected a lack of inventory available. Determination of the location and number of frames 304 can take place at a camera, or in embodiments frames 304 can be superimposed upon images sent from a camera to an inventory management system.

In embodiments, frames 304 can be superimposed on images of shelves (302A, 302B, 302C, 302D, 302E) when insufficient light is reflected back towards the camera. In this binary type of optical detection system, the existence of any product on a shelf is detected based on relatively higher reflectance than an empty shelf. Variations on this binary optical detection system include shelves with white backing (to increase the gain and make even products with dark-colored packaging more apparent), shelves with dark backing (to make products with light-colored packaging more apparent) or, in some embodiments, visible backing patterns or illumination that are blocked by any products.

FIG. 10A also depicts frame 304′ that is partially filled by a product. In embodiments, frames 304 correspond to particular segments of shelves (302A, 302B, 302C, 302D, 302E) and the determination of whether a frame 304 is full or empty is determined based on what portion of that frame 304 is filled. For example, in embodiments a frame 304′ could be identified as empty if more than half of the area is determined to be empty. For some products, such as very short products or very small products, the portion of frame 304′ that must be filled before it is counted as fully stocked may be lower. For other types of products that are stackable, such as canned goods, each frame 304 can be assigned a percentage stocked based on the percentage of the visually observable area of the frame 304 that has visible product available.

Visual data within frames 304 can be used to determine not just whether inventory is low, but more particularly whether inventory is accessible. Accessible products are those that are visually observable to a customer walking down an aisle of shelves, for example. Conventional

RFID systems may detect whether product is on the shelf or not, or even the quantity of a certain product on a shelf. RFID cannot, however, determine whether the product is on the front of the shelf or relegated to the very back, where customers will not see it. Likewise, RFID is not capable of determining whether a product is facing forward or backward on the shelf If a customer is looking for a particular product based on its label and all of the product labels are turned backwards, the product is not accessible. Likewise, if product is present on a shelf but has been hidden behind an obstruction such as another product that has been stocked in front of it, an RFID system will still report that the product is available on the shelf. This is not helpful to a a customer who is looking for, yet cannot find, the hidden product. Therefore the visual data shown in FIG. 10A can be used to determine accessibility of a product, which is more valuable information than simply determining the existence of a product on a shelf.

FIG. 10B also depicts optical data detected by a camera. FIG. 10B is annotated to show product labels and pricing information. As previously described with respect to FIG. 10A, the annotations can be added by a camera itself, or by a centralized computer system such as an inventory management server (e.g., 104) running a rules engine (e.g., 102). As shown in FIG. 10B, data collected by a camera can include product 402 on a shelf, label 404 on the shelf and corresponding to a product 402, and product movement vectors 406. As described previously with respect to FIG. 10A, product 402 detected on a shelf can be used by an inventory management system (e.g., 100) to determine whether there is a lack of product available, or a lack of accessibility of a product.

Labels 404 are customarily used to provide information to a customer about a product on an adjacent shelf space. Labels 404 can provide information such as price, quantity, and in some cases discounts or specials that are in effect for a particular product 402. In some instances, however, product 402 and label 404 become mismatched from one another due to the product 402 being stocked in the wrong location. In other cases, a customer may move a product 402 from one shelf to another, for example after deciding not to purchase that particular product 402. These moved products, referred to herein as “plugged” products, should preferably be returned to their original location. Otherwise, plugged products may hide available merchandise, or the mismatch between the plugged product 402 and the label 404 underneath it may confuse customers as to what it is and how much it costs.

Product movement vectors 406 indicate movement of products 402. In FIG. 10B, various products 402 have been plugged, or should be moved from one area to another, as indicated by product movement vectors 406. Product movement vectors 406 can be determined by an inventory management system (e.g., 100) and used to direct an associate to manage the inventory to make the products more accessible.

In embodiments, product movement vectors 406 can be used for directing restocking, movement of plugged items, relabeling labels 404, or redistributing products 402 along the shelf. An inventory management system can prioritize between these tasks and others. For example, a plugged item can be prioritized higher than a low inventory condition. A plugged item that has been placed adjacent to a label 404 indicating a sale price on a similar item could be prioritized higher than a plugged item that has been placed adjacent to a label 404 that is unlikely to cause confusion over price, in another example.

In FIGS. 10A and 10B, the optical detection systems or cameras are used to detect product placement on a shelf. In embodiments, optical detection systems could be used to detect the placement of products on shelves, racks, floor displays, end caps, top stock, backroom storage, carts, or any other location where products are located in storage or in a sales area. To detect products in each of these locations, different cameras or other optical detection systems can be used. In one embodiment, cameras can be mounted to shelves on one side of an aisle, facing the opposite side of the aisle to detect the placement of products on shelves and racks on the opposite side. In other embodiments, cameras can be mobile, such as by attachment to a drone or robot. Other mobile cameras can be operated by an associate, such as by using a camera on a handheld device, restocking cart, or other mobile device.

In embodiments, visual data measured by such cameras measures accessibility of the products available in a retail environment by detecting the products and/or labels that are visible to a customer, which can be different from mere product quantities available. As described above, accessibility can include not just whether the product is present in the store. Rather, accessibility of the product includes a determination of whether the product is in the correct location, coupled with an accurate label, positioned in a way that labels or other important information is readily apparent, and arranged at the front of a shelf or rack rather than in an obscured or obstructed location.

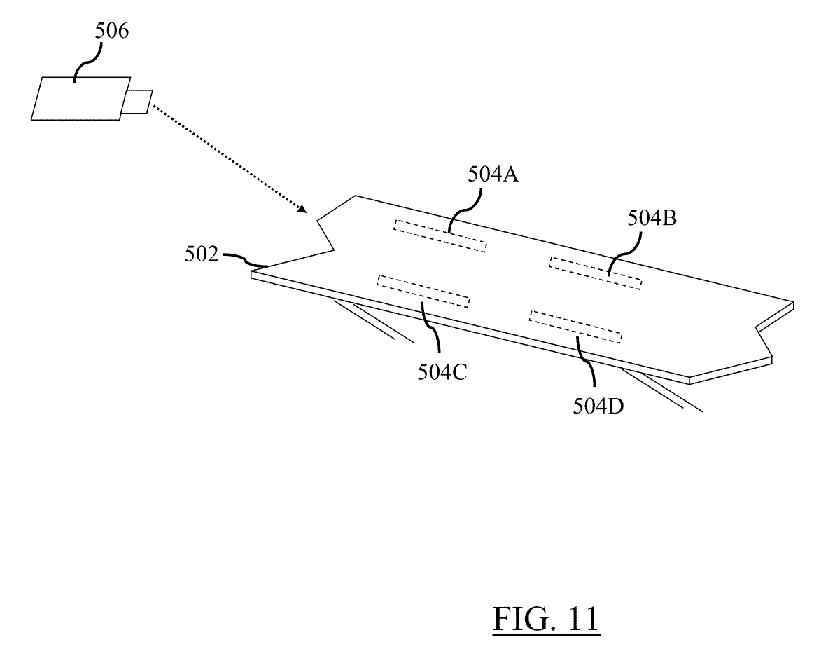

FIG. 11 depicts a portion of shelf 502 that is a part of an autonomously-reporting inventory management system. Shelf 502 includes weight sensors 504A, 504B, 504C, and 504D. Weight sensors 504A-504D are arranged along shelf 502 to detect not only presence of products thereon, but also arrangement of products on shelf 502. For example, if weight sensors 504A and 504B detect a relatively higher quantity of weight than weight sensors 504C and 504D, then the data from weight sensors 504A-504D indicate that the majority of the product arranged on that shelf 502 is at the back, and may not be as accessible as if it were arranged toward the front of shelf 502. Similarly, if all of the weight sensors 504A-504D indicate a weight that is low, the data can indicate that restocking is needed.

In embodiments, data from weight sensors 504A-504D can be compared with known product information such as overall weight per item to determine a quantity of that item remaining on the shelf. Restocking tasks can be generated and assigned not only based on an overall lack of weight on shelf 502, but rather based upon weight on shelf divided by the weight per item. That information in turn can be compared to inventory management data regarding how quickly

Weight detection can be used in isolation to generate tasks related to restocking or rearranging products. Each sensor 504A-504D can include an antenna or other transmission hardware to send weight data to a centralized inventory management system, in embodiments. Alternatively, a transmission subsystem can be communicatively coupled to each of the weight sensors associated with a particular shelf, rack, floor display, or other area where products are located. Weight sensors 504A-504D can be capacitive sensors, mechanical sensors, compression sensors, or sensors that detect a change in angle of a shelf or other display that is indicative of weight distribution, for example.

FIG. 11 also shows camera 506. As described above with respect to FIGS. 10A and 10B, camera 506 can detect characteristics of a display including position, orientation, and “plugged” products that are in the wrong place, which can be difficult or impossible to detect using weight sensors alone. Similarly, weight sensors 504A-504D can detect the presence of products in locations such as at the back of shelf 502 that may not be discernible with camera 506 alone. The combined data can be used by an inventory management system (e.g., 100) to gather a highly accurate representation of the availability and the accessibility of products. All of the weight sensors 504A-504D and camera 506 can, in embodiments, be configured for autonomous communication with an inventory management system to expedite those determinations and to more rapidly and efficiently deploy associates to complete stocking, restocking, and other tasks.

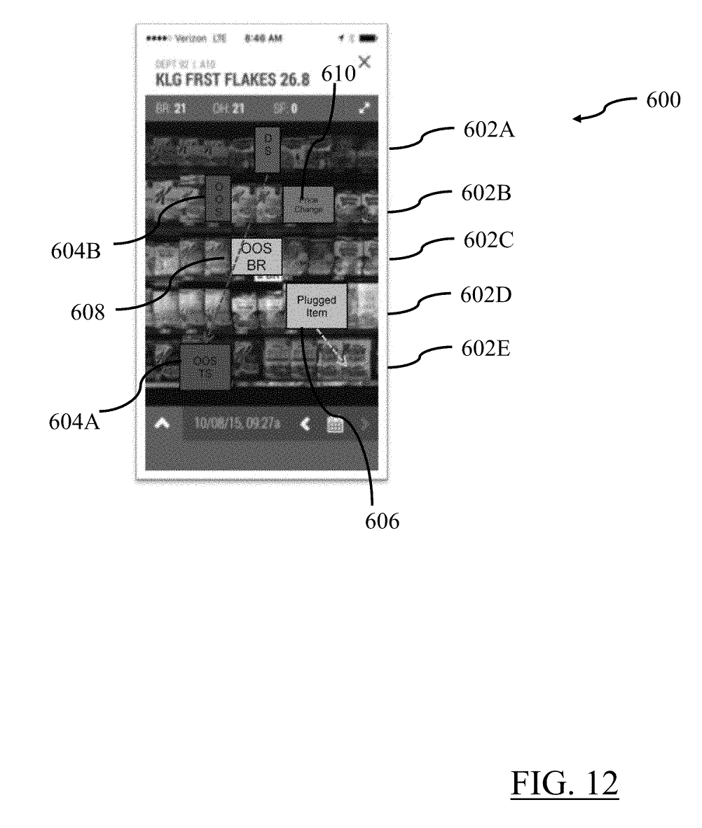

FIG. 12 is a depiction of an API screen that could be provided to a store associate using an inventory management system that includes weight and optical sensors as described above. Screen 600 can be presented on a mobile device, for example, that an associate carries through the store as described in FIGS. 6-9. Upon reaching a shelf at the device's directions, screen 600 includes an image of shelves 602A-602E. The depiction of shelves 602A-602E can be taken from a camera as described with respect to FIGS. 10A and 10B.

Based on optical data from a camera and/or weight data captured by weight sensors on the shelves 602A-602E, instructions can be presented graphically on screen 600. In the example shown in FIG. 12, two out-of-stock locations have been identified (604A and 604B). Out-of-stock location 604A is coupled with a product movement vector (indicated with an arrow in FIG. 12) that shows availability of additional product in topstock. Another instruction on screen 606 indicates the existence of a plugged item on shelf 602D, and is likewise tied to a product movement vector (indicated with an arrow in FIG. 12) that shows the correct position on shelf 602E for that product. Another instruction on screen 606 shows an out-of-stock product 608 on shelf 602C, and an indication that additional product is available in the back room. Another instruction 610 shows that a label should be changed to indicate a price change on shelf 602B. Providing instructions (e.g., 604A, 604B, 606, 608, 610) overlaid on a camera image of the product display (e.g., shelves 602A-602E) provides an intuitive way for associates to quickly and easily complete the desired tasks at each location throughout a store.

In one embodiment, an inventory auditing management system includes a rules engine comprising a set of inventory audit rules, at least one of the rules comprising a prioritization definition based on a real time on-shelf customer availability (OSCA) of a product. The inventory auditing management system can also include an inventory database comprising inventory data. The inventory auditing management system can include an inventory audit application program interface (API) communicatively coupled with the rules engine and the inventory database and configured to build a plurality of different dynamic audit task lists based on the set of inventory audit rules and the inventory data. A plurality of mobile electronic devices can each be configured to host an instance of the inventory audit API to present one of the plurality of different dynamic audit task lists in a user interface, the user interface configured to present the dynamic audit task list as a series of discrete tasks and receive input data in response to each discrete task. The inventory API can be configured to update any of the inventory data, the series of discrete tasks, or at least one of the plurality of different dynamic audit task lists, based on the received input data.

In some embodiments, the at least one of the plurality of different dynamic audit task lists updated based on the received input data is the dynamic audit task list presented on the mobile electronic device that received the input data. The at least one of the plurality of different dynamic audit task lists can be updated based on the received input data that is another one of plurality of different dynamic audit task lists than the one presented on the mobile electronic device that received the input data. The inventory data can include a product location, and the inventory API can be configured to build the plurality of different dynamic audit task lists based at least in part on an efficient physical route to be taken between a plurality of product locations. The at least one of the discrete tasks can be a product stocking or fulfillment task. The inventory data can be updated as a result of the product stocking or fulfillment task. The mobile electronic device can be at least one of a smartphone, a tablet computer, or a mobile retail computer device such as an MC40 or a TC70. The series of discrete tasks can be a set of binary questions. The mobile electronic device can be configured to prompt a user to address each of the series of discrete tasks. The prompt can include at least one of a visual prompt on the user interface, an audible prompt presented by the mobile electronic device, or a haptic prompt presented by the mobile electronic device. At least one of the rules can be a prioritization definition based on reconciling historical inventory errors, a prioritization definition based on products or sections of products not inventoried recently, or a prioritization definition based on products or sections of products requiring resolution of past inventory issues. At least one of the rules can include checking for product in an inventory overstock location.

According to another embodiment, a method of managing inventory auditing includes defining a set of inventory audit rules, at least one of the rules comprising a prioritization definition based on a real time on-shelf customer availability (OSCA) of a product, and storing the defined set of inventory rules in a rules engine. The method further includes building, by an inventory audit application program interface (API), a plurality of different dynamic audit task lists based on the set of inventory audit rules and inventory data called from an inventory database. The method further includes presenting each of the plurality of different dynamic audit task lists in a user interface of a hosted instance of the inventory audit API on a respective plurality of mobile electronic devices, wherein the presenting includes providing a series of discrete tasks of the dynamic audit task list in the user interface. The method further includes receiving input data in each user interface in response to each discrete task, and updating, by the inventory audit API, any of the inventory data in the inventory database, the series of discrete tasks, or at least one of the plurality of different dynamic audit task lists, based on the received input data.

In embodiments, updating the at least one of the plurality of different dynamic audit task lists updated based on the received input data can include updating the dynamic audit task list presented on the mobile electronic device that received the input data. In embodiments, the method can include updating the at least one of the plurality of different dynamic audit task lists updated based on the received input data comprises updating another one of plurality of different dynamic audit task lists than the one presented on the mobile electronic device that received the input data. In embodiments, the inventory data comprises a product location, and the building comprises building the plurality of different dynamic audit task lists based at least in part on an efficient physical route to be taken between a plurality of product locations. In embodiments, providing a series of discrete tasks comprises providing at least one product stocking discrete task or fulfillment discrete task. In embodiments, the method further includes updating the inventory data as a result of the product stocking discrete task or fulfillment task discrete task. In embodiments, providing a series of discrete tasks comprises presenting a set of binary questions. In embodiments, providing a series of discrete tasks comprises prompting a user to address each of the series of discrete tasks. In embodiments, prompting comprises providing at least one of a visual prompt on the user interface, an audible prompt presented by the mobile electronic device, or a haptic prompt presented by the mobile electronic device. In embodiments, defining a set of inventory audit rules comprises defining at least one of the rules as at least one of: a prioritization definition based on reconciling historical inventory errors; a prioritization definition based on products or sections of products not inventoried recently; or a prioritization definition based on products or sections of products requiring resolution of past inventory issues. In embodiments, defining a set of inventory audit rules comprises defining at least one of the rules as checking for product in an inventory overstock location.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. An inventory auditing management system comprising:
an optical detection subsystem including an optical sensor and configured to autonomously communicate realtime on-shelf customer availability (OSCA) of a product, product position, and product orientation based on optically detected information;
a weight detection subsystem including a weight sensor and configured to autonomously communicate OSCA of a product and product position based on weight distribution on a shelf;
a plurality of handheld devices each having a display, each of the plurality of handheld devices configured to host an instance of an inventory audit application programming interface (API) to present one of a plurality of different dynamic audit task lists in the corresponding display; and
a host device communicatively coupled to the optical detection subsystem, the weight detection subsystem, and each of the plurality of handheld devices, the host device including:
an inventory database comprising product perpetual inventory data;
a rules engine module configured to carry out a set of inventory audit rules, at least one of the set of inventory audit rules comprising a prioritization definition based on at least one of the product perpetual inventory data, the realtime OSCA, the product position, and the product orientation; and
an instance of the inventory audit API configured to build the plurality of different dynamic audit task lists based on the set of inventory audit rules and the OSCA of a product, product position, and product orientation obtained from the optical detection subsystem and the weight detection subsystem.

2. The system of claim 1, wherein the optical detection subsystem is a part of the handheld device.

3. The system of claim 1, wherein the optical detection subsystem is a drone.

4. The system of claim 1, wherein the optical detection subsystem is one or more cameras arranged in a facility.

5. The system of claim 1, wherein the optical detection system is a robot and the optical sensor is a camera coupled to the robot.

6. The system of claim 1, wherein the weight detection subsystem comprises a weight sensor positioned at a shelf to detect a mass positioned on the shelf.

7. The system of claim 1, wherein the weight detection subsystem comprises a set a weight sensors positioned at a shelf to detect distribution of a mass positioned on the shelf.

8. The system of claim 1, wherein the optical detection subsystem and the weight detection subsystem are configured to autonomously send information related to the OSCA of a product, product position, and product orientation based on at least one: of expiration of a set interval; change in the OSCA of the product, the product position, or product orientation; a request from the host device; and a prompt from one of the plurality of handheld devices.

9. The system of claim 1, wherein each of the displays is configured to present the dynamic audit task list as a series of discrete tasks and receive input data in response to each discrete task.

10. The system of claim 1, wherein the optical sensor is configured to detect at least one of product quantity, product location, and product orientation.

11. The system of claim 1, wherein the product perpetual inventory data comprises a product location, and the inventory API is configured to build the plurality of different dynamic audit task lists based at least in part on an efficient physical route to be taken between a plurality of product locations.

12. The system of claim 1, wherein the inventory API is configured to build the plurality of different dynamic audit task lists based at least in part on a product orientation detected by the optical sensor.

13. The system of claim 1, wherein at least one of the discrete tasks is a product stocking or fulfillment task.

14. The system of claim 5, wherein the product perpetual inventory data is updated as a result of the product stocking or fulfillment task.

15. The system of claim 1, wherein the mobile electronic device comprises at least one of a smartphone, a tablet computer, or a mobile retail computer device.

16. The system of claim 1, wherein at least one of the plurality of different dynamic audit task lists includes a set of binary questions.

17. The system of claim 16, wherein the mobile electronic device is configured to prompt a user to address each of the set of binary questions.

18. The system of claim 17, wherein the prompt comprises at least one of a visual prompt on one of the displays, an audible prompt presented by the mobile electronic device, or a haptic prompt presented by the mobile electronic device.

19. The system of claim 1, wherein at least one of the rules comprises at least one of:
a prioritization definition based on reconciling historical inventory errors;
a prioritization definition based on a product orientation detected by the optical sensor;
a prioritization definition based on a product location detected by at least one of the optical detection subsystem and the weight detection subsystem;
a prioritization definition based on a product weight distribution detected by the weight detection subsystem;
a prioritization definition based on products or sections of products not inventoried recently; or
a prioritization definition based on products or sections of products requiring resolution of past inventory issues.

20. The system of claim 1, wherein at least one of the rules comprises checking for product in an inventory overstock location.
